(19) United States
(12) Patent Application Publication
(10) Pub. No.: US 2002/0156895 A1
(43) Pub. Date: Oct. 24, 2002

(54) System and method for sharing contact information

(76) Inventor: Michael T. Brown, Flemington, NJ (US)

Correspondence Address: HEWLETT-PACKARD COMPANY, Intellectual Property Administration, P.O. Box 272400, Fort Collins, CO, 80527-2400, US

(21) Appl. No.: 09/839,771

(22) Filed: Apr. 20, 2001

(51) Int. Cl. G06F 15/16; G06F 15/173; G09G 5/00

(52) U.S. Cl. 709/226; 709/229; 345/741

(57) ABSTRACT

The present disclosure relates to a system and method for sharing contact information. In one arrangement, the method comprises the steps of storing a user's contact information in a database accessible over a network, receiving identification of a person that the user wishes to authorize for access the user's contact information, enabling the person to access to the user's contact information, and transmitting the user's contact information to a computing device of the authorized person from the database via the network in response to a request for this information. According to this method, therefore, the user can store and re-store (i.e., update) his or her contact information such that others can access the most current contact information for the user.

### FIELD OF THE INVENTION

The present disclosure relates to a system and method for sharing contact information. More particularly, the disclosure relates to a system and method for accessing contact information over a computer network and for controlling others' access to one's own contact information.

### BACKGROUND OF THE INVENTION

Traditionally, individuals have shared their contact information by, for instance, verbally communicating it or by exchanging business cards. Once shared in this manner, the recipient would then record this information in an address book or rotary organizer. More recently, individuals have used electronic address books to record this information. With electronic storage of the information, the information can be accessed from more than one source, e.g., from a desktop computer as well as a personal digital assistant (PDA).

Whether contact information is recorded in a hardcopy or digital address book, the information can vary quick become outdated. For instance, with the high mobility of people in today's world, it is unlikely that contact information that was recorded several years ago will be accurate as to any given person. Although this problem may not arise for persons with whom one is familiar on a frequent basis, e.g., family and close friends, it can arise much more frequently with more casual acquaintances. For example, in the personal realm, an individual that graduated from a particular high school likely will lose touch with many people with which he or she was once familiar. To cite an example in the business realm, an individual may lose contact with many of his or her former coworkers, particularly where the individual worked with them early in the individual's career when job-changing is most likely.

Although individuals can possibly avoid the aforementioned problems by maintaining communications and diligently updating their records, for most of us loss or obsolescence of contact information is nearly inevitable. Even where an individual is able to maintain relatively up-to-date contact information, a substantial amount of time can be spent in updating and re-updating records. Furthermore, if the individual mistakenly records the wrong information, contact with a person can be lost permanently. Moreover, where the individual maintains a large digital address book, a substantial amount of storage space may be required to house the contacts data. Although this is generally not a problem where the address book is stored on a desktop computer, it can be problematic where the storage device comprises a handheld device such as a PDA or a mobile telephone which tend to have less available storage space.

Recently, a system has been made available online (www.ecardfile.com) with which individuals can store their contact information. Although providing some measure of flexibility to persons that wish to access this contact information, this system does not provide the individual with much control over his or her information. In particular, once provided to the system, the user's information is available to all persons that access the web site, not just those that the individual designates. Accordingly, the individual's information can potentially be misused (e.g., for marketing purposes, etc.).

From the foregoing, it can be appreciated that it would be desirable to have a system and method for sharing contact information that avoids one or more of the disadvantages identified above.

### SUMMARY OF THE INVENTION

The present disclosure relates to a method for sharing contact information. In one arrangement, the method comprises the steps of storing a user's contact information in a database accessible over a network, receiving identification of a person that the user wishes to authorize for access the user's contact information, enabling the person to access to the user's contact information, and transmitting the user's contact information to a computing device of the authorized person from the database via the network in response to a request for this information. In such a method, therefore, the user can store and re-store (i.e., update) his or her contact information such that others can access the most current contact information for the user.

In addition or alternatively, the method for sharing data comprises the steps of receiving a user's identification that conveys the user's authorization to access contact information, receiving a request to view contact information, retrieving the requested contact information from a remote database via a network, and displaying the contact information to the user.

The present disclosure further relates to systems for sharing data. In one arrangement, the system comprises means for storing a user's contact information in a location accessible over a network, means for receiving an identification of persons that a user authorizes to access the user's contact information, means for enabling the persons to access to the user's contact information, and means for transmitting the user's contact information to a computing devices of the authorized persons from the database in response to requests for this information.

In addition or alternatively, the system for sharing data comprises means for verifying a user's authorization to access contact information, means for receiving a request to view contact information, means for retrieving the requested contact information from a remote database accessible via a network, and means for displaying the contact information to the user.

The features and advantages of the invention will become apparent upon reading the following specification, when taken in conjunction with the accompanying drawings.

### BRIEF DESCRIPTION OF THE DRAWINGS

The invention can be better understood with reference to the following drawings. The components in the drawings are not necessarily to scale, emphasis instead being placed upon clearly illustrating the principles of the present invention.

FIG. 1 is a schematic view of a system for sharing contact information.

FIG. 2 is a schematic view of a computing device shown in FIG. 1.

FIG. 3 is a schematic view of a network server shown in FIG. 1.

FIG. 4 is a flow diagram that illustrates a first mode of operation of a contacts information module shown in FIG. 2.

FIG. 5 is a flow diagram that illustrates a second mode of operation of the contacts information module shown in FIG. 2.

FIG. 6 is a flow diagram that illustrates a third mode of operation of the contacts information module shown in FIG. 2.

FIG. 7 is a flow diagram that illustrates an example method for sharing contact information.

### DETAILED DESCRIPTION

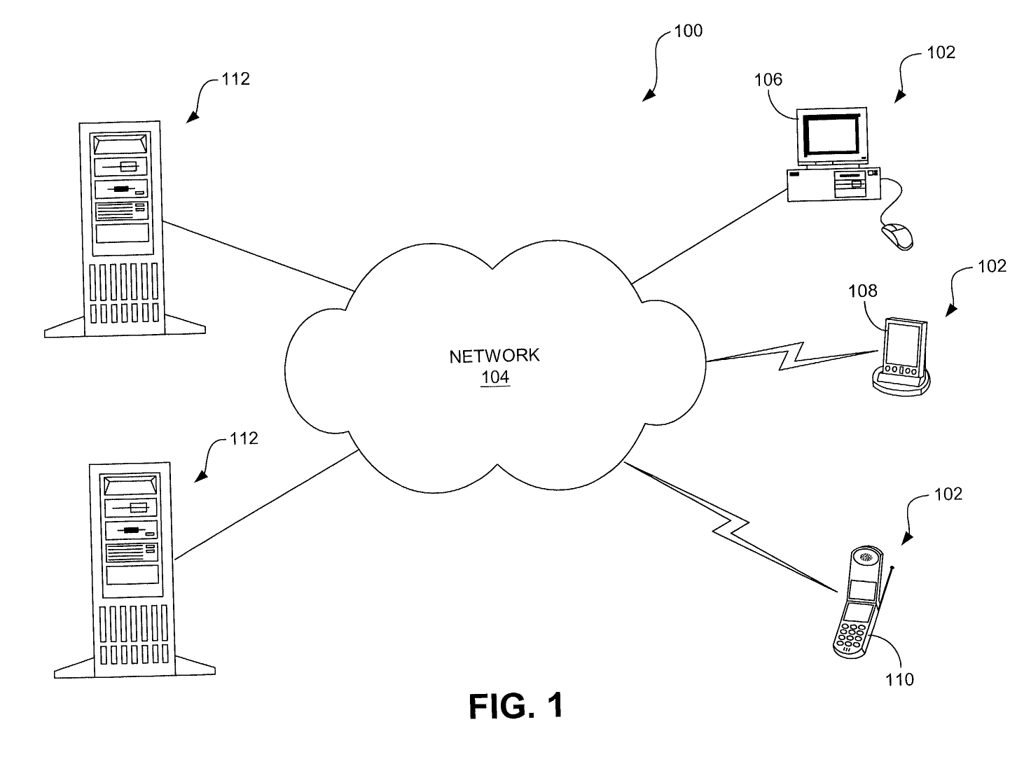

Referring now in more detail to the drawings, in which like numerals indicate corresponding parts throughout the several views, FIG. 1 illustrates a system 100 for sharing contacts information. Although the term “contacts information” is used, it will be understood that, as used herein, this term pertains to names, addresses, and telephone numbers, as well as any other information that an individual may be interested in storing in association with a person such as information regarding the person's birthday, anniversaries, etc. Furthermore, although the “individual” and “person” are used herein, it is to be appreciated that these terms are intended to be inclusive and therefore potentially pertain to a business or other entity, where applicable.

As indicated in FIG. 1, the system 100 can comprise one or more computing devices 102 that are each connected to a network 104. The computing devices 102 can each comprise substantially any electrical device that is capable of computational logic including a personal computer (PC) such as a desktop PC 106, a personal digital assistant (PDA) 108, and a mobile telephone 110. Although these devices are shown in FIG. 1 for purposes of example, it will be understood that the computing devices 102 can comprise other configurations. For instance, the computing devices 102 can, alternatively, comprise network-enabled appliances.

As is further indicated in FIG. 1, the computing devices 102 connect to the network 104 either directly (as with the desktop PC 106), or wirelessly (as with the PDA 108 and the mobile telephone 110). Irrespective of the nature of the connection, the computing devices 102 are in some way connected to the network 104 such that they can communicate via the network and therefore send and/or receive data via the network. The network 104 can comprise one or more networks that can include a local area network (LAN) and/or a wide area network (WAN). In a preferred arrangement, however, the network 104 comprises the set of networks that for the Internet. Further included in the system 100 shown in FIG. 1 is one or more network servers 112. As indicated in the figure, each of the servers 112 is connected to the network 104, typically through a direct, physical connection.

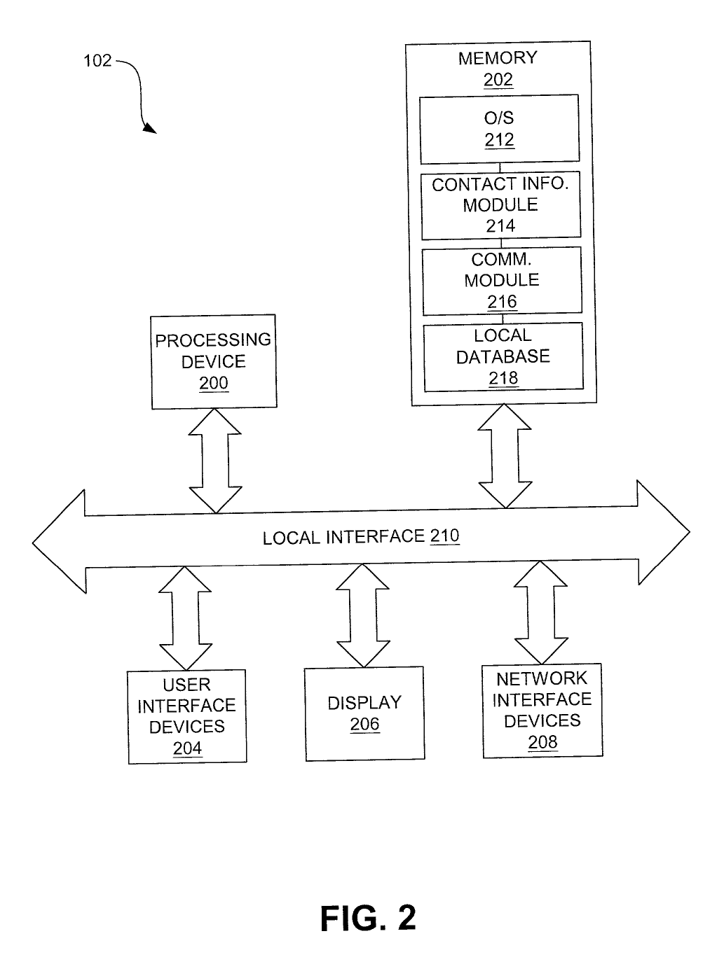

FIG. 2 is a schematic view illustrating an example architecture for a computing device 102 shown in FIG. 1. As indicated in FIG. 2, the computing device 102 comprises a processing device 200, memory 202, user interface devices 204, a display 206, and network interface devices 208. Each of these components is connected to a local interface 210 that, by way of example, comprises one or more internal buses. The local interface 210 may have additional elements, which are omitted for simplicity, such as controllers, buffers (caches), drivers, repeaters, and receivers to enable communications. Furthermore, the interface 210 may include address, control, and/or data connections to enable appropriate communications among the aforementioned components.

The processing device 200 comprises hardware for executing software and/or firmware that is stored in memory 202. The processing device 200 can include any custom made or commercially available processor, a central processing unit (CPU), or an auxiliary processor among several processors associated with the computing device 102, a semiconductor based microprocessor (in the form of a microchip), or a macroprocessor. Alternatively, the processing device 200 can comprise one or more application-specific integrated circuits (ASICs), a plurality of suitably configured digital logic gates, and other known electrical configurations comprised of discrete elements both individually and in various combinations to coordinate the overall operation of the computing device 102.

The memory 202 can include any one of combination of volatile memory elements (e.g., random access memory (RAM, such as DRAM, SRAM, etc.)) and nonvolatile memory elements (e.g., ROM, hard drive, tape, CDROM, etc.). Moreover, the memory 202 can incorporate electronic, magnetic, optical, and/or other types of storage media. Note that the memory 202 can have a distributed architecture, where various components are situated remote from one another, but accessible by the processing device 200. The user interface devices 204 comprise the tools with which a user can control and communicate commands to the computing device 102. Where the computing device 102 comprises a desktop PC (e.g., PC 106), these interface devices 204 typically comprise a keyboard, mouse, etc. Where the computing device 102 comprises a handheld device such as PDA 108 or mobile telephone 110, the interface devices 204 can comprise one or more function keys and a touch-sensitive screen (e.g., liquid crystal display (LCD)) with which the user can view information and communicate commands to the computing device 102. The display 206 can comprise a monitor in the case of the PC, and the touch-sensitive screen (when provided) or alternative LCD in the case of a handheld device.

The network interface devices 208 comprise the hardware with which each computing device 102 transmits and receives information over the network 104. In particular, the network interface devices 208 include components that communicate both inputs and outputs, for instance, a modulator/demodulator (e.g., analog, digital subscriber line (DSL), or cable modem), a radio frequency (RF) or other transceiver, a telephonic interface, a bridge, a router, etc. Where RF transmission is used, various protocols can be implemented including Bluetooth™ from Bluetooth SIG™ and 802.11 protocol in compliance with institute of electrical and electronics engineers (IEEE) specifications.

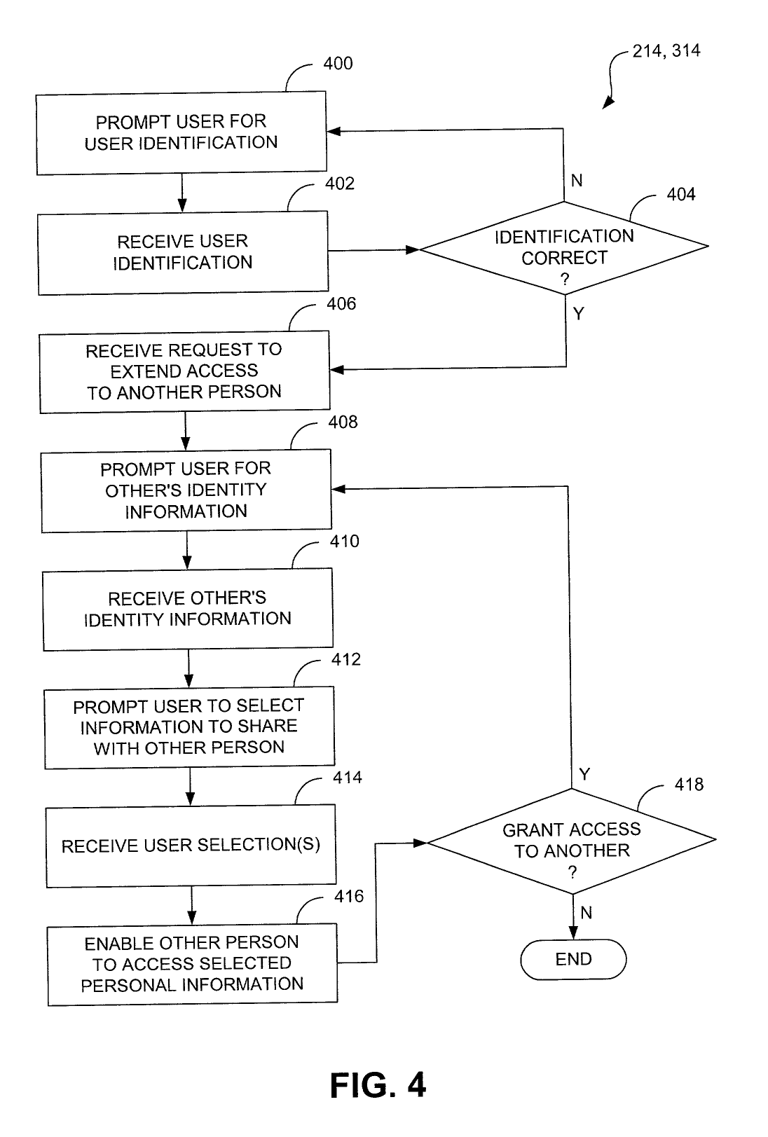

As is also indicated in FIG. 2, the memory 202 comprises various software and/or firmware programs. In particular, the memory 202 includes an operating system 212, a contacts information module 214, and a communications module 216. In addition, the memory 202 can, optionally, include a local database 218. The operating system 212 controls the execution of other software and/or firmware, such as the contacts information module 214, and provides scheduling, input-output control, file and data management, memory management, and communication control and related services. The contacts information module 214 comprises one or more applications with which contacts information can be shared. More particularly, as is described in more detail below with reference to FIGS. 4-6, the contacts information module 214 preferably comprises one or more applications that are adapted to permit an individual to grant access to his or her contact information, to revoke access to the contact information, and to permit the individual to access another's contact information. The communications module 216 is adapted to, in conjunction with the network interface devices 208, facilitate communications between the computing device 102 and another device (e.g., network server 112) via the network 104. When provided, the local database 218 can be used to store various data, for instance the user's contact information and/or the contact information for various other persons.

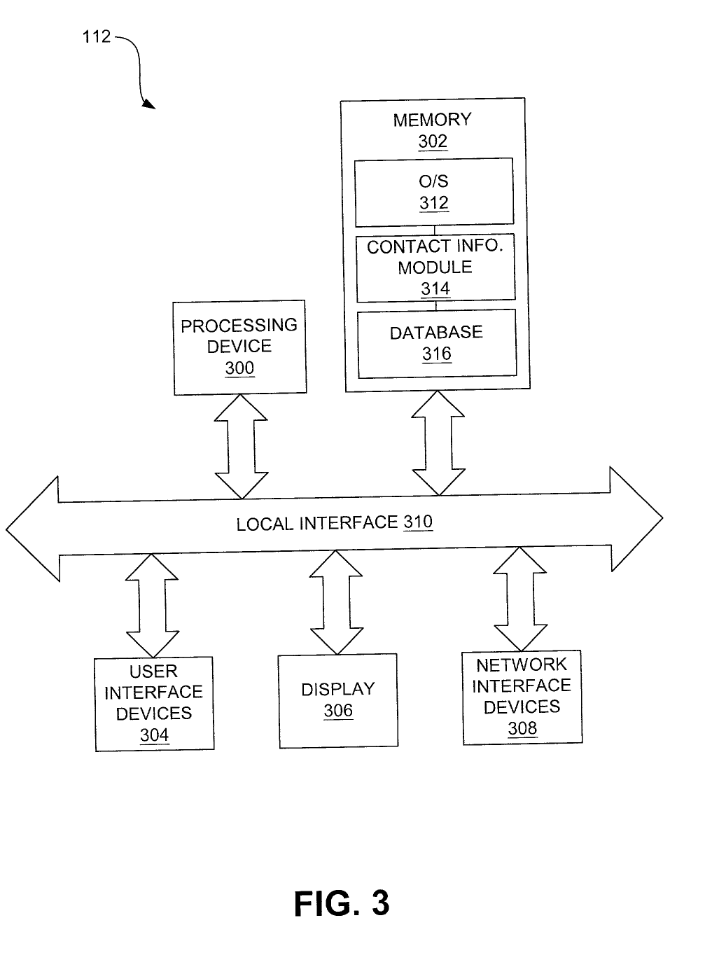

FIG. 3 is a schematic view illustrating an example architecture for the one or more network servers 112 shown in FIG. 1. As indicated in FIG. 3, each network server 112 can also comprise a processing device 300, memory 302, user interface devices 304, a display 306, network interface devices 308, and a local interface 310 to which each of the other components electrically connects. The processing device 300 can again include any custom made or commercially available processor, a central processing unit (CPU) or an auxiliary processor among several processors associated with the network server 112, a semiconductor based microprocessor (in the form of a microchip), or a macroprocessor. Similarly, the memory 302 can also include any one of combination of volatile memory elements (e.g., random access memory (RAM, such as DRAM, SRAM, etc.)) and nonvolatile memory elements (e.g., ROM, hard drive, tape, CDROM, etc.). The user interface devices 304 typically comprise those normally used in conjunction with a server, such as a keyboard, mouse, etc., and the display 306 typically comprises a monitor. The network interface devices 308 comprise the hardware with which the network server 112 transmits and receives information over the network 104.

The memory 302 comprises various software programs including an operating system 312 and a contacts information module 314. The operating system 312 controls the execution of other software and provides scheduling, input-output control, file and data management, memory management, and communication control and related services. The contacts information module 314 is similar in nature to the contacts information module 214 of the computing device 102 shown in FIG. 2. Typically, however, the contacts information module 314 is accessed remotely, e.g., with a computing device 102, instead of locally as with the contact information module 214. Due to the similarities of operation between these two modules, however, the module 314 is described along with the module 214 in relation to FIGS. 4-6. In addition, the memory 302 includes a database 316 that is used to store contacts information. In a preferred arrangement, the database 316 stores the contacts information that is to be accessed by many different users. In such circumstances, the network server 112 is therefore used as a central repository for contacts information that can be accessed by many over the network (e.g., Internet).

Various software and/or firmware modules have been described herein. It is to be understood that these modules can be stored on any computer readable medium for use by or in connection with any computer related system or method. In the context of this document, a computer readable medium is an electronic, magnetic, optical, or other physical device or means that can contain or store a computer program for use by or in connection with a computer related system or method. These modules can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device.

The computer readable medium can be, for example but not limited to, an electronic, magnetic, optical, electromagnetic, infrared, or semiconductor system, apparatus, device, or propagation medium. More specific examples (a nonexhaustive list) of the computer-readable medium include an electrical connection having one or more wires, a portable computer diskette, a random access memory (RAM), a read-only memory (ROM), an erasable programmable read-only memory (EPROM, EEPROM, or Flash memory), an optical fiber, and a portable compact disc read-only memory (CDROM). Note that the computer-readable medium could even be paper or another suitable medium upon which a program is printed, as the program can be electronically captured, via for instance optical scanning of the paper or other medium, then compiled, interpreted or otherwise processed in a suitable manner if necessary, and then stored in a computer memory.

With the arrangement shown in FIGS. 1-3, users can share contact information with ease. To enable this information sharing, an individual (i.e., “user”) first stores his or her contact information at a location that others, when provided with proper authorization, can access. In a preferred arrangement, this information is stored by the user through use of an application of the contacts information module 214, 314. In either case, the application can comprise a network site (e.g., website) generated by the module 314. Alternatively, the application can be a program running on the computing device 102. Regardless, the application can be configured to provide a plurality of data fields in which the individual(s) can enter information and pull-down menus that comprise various information the user can select. Once the user's contact information is entered, it is stored by the contact information module 214, 314. In one arrangement, the information can be stored locally in the local database 218 of the computing device 102 only. Preferably, however, the information is at least stored remotely in the database 316 provided in the network server 112 such that other persons will be able to more easily access the information. Optionally, the information can be stored both at the local database 218 as well as the remote database 316, and the local database information automatically updated periodically with reference to the remote database 316 (which typically will contain the most up-to-date information). As will be apparent from the discussion that follows, these storage arrangements permit individuals to update their own contact information at a single location such that all authorized persons will be able to obtain the most up-to-date information for the individual.

FIG. 4 illustrates a first mode of operation of the contacts information module 214, 314. As identified above, the contacts information module 214, 314 comprises one or more applications that are adapted to enable various functionalities. Depicted in FIG. 4 is the grant of access to an individual's contact information. For example, if the individual (i.e., the “user”) meets another person and wishes to share the user's contact information with that person, the user can give the person access to the information. To accomplish this, the application adapted for this particular functionality is first initiated in some manner by the user. Where application is one of the local contacts information module 214, this initiation can comprise the opening of a program that runs on the computing device 102. Alternatively, where the application pertains to the remote contact information module 314, initiation may comprise simply accessing a web site that is configured for the intended functionality.

In any case, once the application is initiated, the user is prompted for some form of user identification by the contacts information module 214, 314 to establish the fact that the user is authorized to access the application, as indicated in block 400. The identification can, for example, comprise the entry of a username and password combination (i.e., a log in) as is conventional in the art. Alternatively, this identification can be communicated through another means such as through the entry of an appropriate code, provision of an appropriate key, and so forth. Once the identification is provided, it is received by the contacts information module 214, 314, as indicated in block 402, and it can be determined whether the identification is correct, as indicated in decision element 404. If the identification is incorrect, for instance if the user enters the wrong username and/or password by mistake, flow returns to block 400 at which the user is again prompted for the user identification. If, however, the identification is correct (i.e., the user is authenticated), flow continues to block 406 at which the contacts information module 214, 314 receives the user's request to extend access to another person.

At this point, the contacts information module 214, 314 prompts the user for the identity information for the other person, as indicated in block 408. Like the user identification described above, this identity information can comprise some form of code that identifies the authorization of the other person to gain access to the user's contact information. In a preferred arrangement, however, the identity information simply comprises the person's identity, for example “john_doe” or the person's email address, for example, “john_doe@xyz.com”. Once this identity information is received, as indicated in block 410, the user is prompted to select the contact information that will be shared with the identified person when that person later attempts to access the user's contact information, as indicated in block 412. Configured in this manner, the contact information module 214, 314 permits the user to control just what information the identified person will be able to view. By way of example, the user can be presented with default selections that pertain to specific groups of information. For instance, the default selections could include a “all” information, “personal” information, and “business” information options in which access would be provided to all the user's contact information, only personal information (e.g., home and mobile telephone numbers, home address), or only the individual's business information (e.g., business phone number and business address), respectively. In addition or alternatively, the user can be provided with the ability to manually select (or deselect as the case may be) each piece of information that is to be shared.

Once the user selections are received, as indicated in block 414, the contacts information module 214, 314 enables the identified person to access the information that has been selected by the user, as indicated in block 416. Persons having ordinary skill in the art will appreciate that such enablement can be facilitated in many different ways. By way of example, person's identity can be added to an “approved” list associated with the stored contact information along with an identification of the particular information for which the person is approved such that, when the person later attempts to access the information, his or her identity will be cross-referenced with the approved list to confirm that the person has authorization as well as to determine the applicable level of the authorization. At this point, it can be determined whether access is to be granted to a further person, as indicated in decision element 418. If not, then flow is terminated. If further access is to be extended, however, flow returns to block 408 at which the user is prompted to provide the other person's identity information. Operating in the manner described above, the contacts information module 214, 314 can be used to store one's contact information as well as grant controlled access to other persons as the user sees fit. If the user maintains the accuracy of his or her own contact information by updating it as the information changes, persons accessing the user's information will automatically be able to obtain up-to-date contact information as long as the persons' privileges are not revoked.

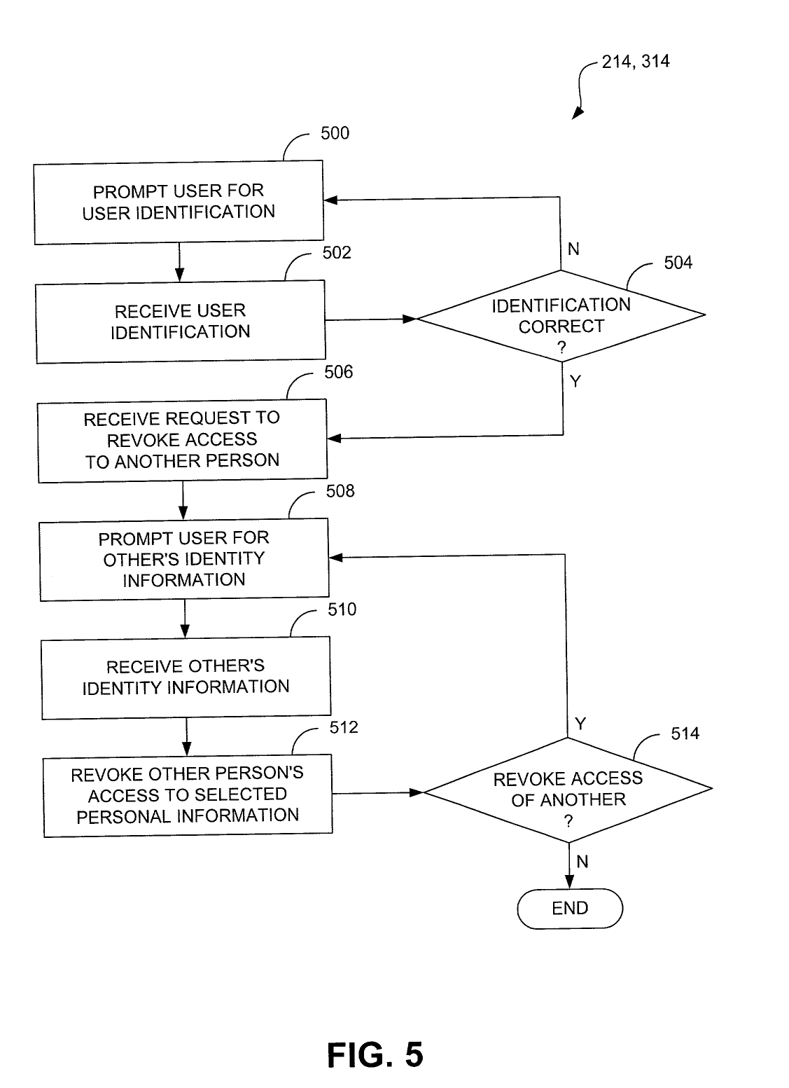

To provide the user with greater control over who can obtain the user's information and what information is shared, the contacts information module 214, 314 is also configured such that the user can revoke access that has been extended. FIG. 5 illustrates an example operation of the contacts information module 214, 314 in this capacity. Again, an application (preferably the same application described above) of the contacts information module 214, 314, is first initiated. After the application is initiated, the user is again prompted for a user identification (e.g., username and password), as indicated in block 500. Once the identification is provided, it is received by the contacts information module 214, 314, as indicated in block 502, and the module can determine whether the identification is correct (i.e., whether the user has authorization), as indicated in decision element 504. If incorrect, flow returns to block 500 at which the user is again prompted for the user identification. If, however, the identification is correct, flow continues to block 506 at which the contacts information module 214, 314 receives the user's request to revoke a person's access. In a preferred arrangement, the user can view a list of all persons that have access to the user's contact information. Arranged in this manner, the contact information module facilitates the denial of access, thereby providing the user with more control over with whom his or her information is shared.

The contacts information module 214, 314 can then prompt the user for the identity information for the other person, as indicated in block 508. As described above in relation to FIG. 4, this identity information preferably comprises the person's name, for example in the form of “john_doe” or the person's email address. Once this identity information is received, as indicated in block 510, the identified person's access to the user's contact information is revoked, as indicated in block 512. By way of example, this revocation can simply comprise removal of the person's name (or other identity information) from the approved list associated with the stored contact information. By doing so, the removed person will not be able to access any information of the user and, as described below, preferably will no longer have an entry in his or her own address book for the user. At this point, it can be determined whether other persons' access is to be revoked, as indicated in decision element 514. If not, flow is terminated. If so, flow returns to block 508 at which the user is prompted to identify another person. Although complete revocation is described above, it will be appreciated that partial revocation, i.e., denial of access to certain information (e.g., home address) can be accomplished in similar manner. In such a scenario, the person is not removed from the approved list. Instead, the level of access associated with the person's approval is modified such that less (and/or more as the case may be) information can be accessed by the person.

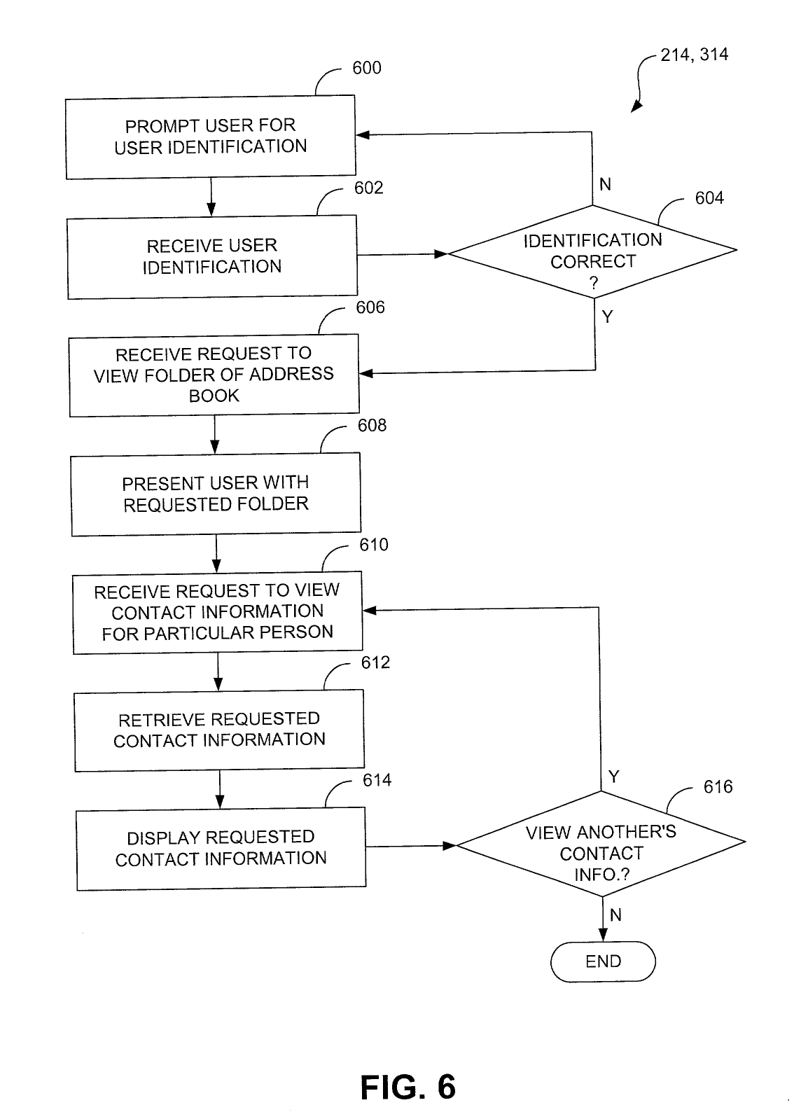

FIG. 6 illustrates an example operation of the contacts information module 214, 314 in an address book capacity. More particularly, FIG. 6 illustrates an example of operation of a virtual address book application (either integrated with or separate from the application described above in relation to FIGS. 4-5) of the module 214, 314 with which the user can access another's information. Once the application is initiated, the user is prompted for some form of user identification (e.g., through a log in process) to convey the user's authorization, as indicated in block 600. Entry of such information facilitates access to the contacts information of the persons identified in the user's virtual address book.

Once the identification is provided, it is received by the contacts information module 214, 314, as indicated in block 602, and the module determines whether the identification is correct, as indicated in decision element 604. If the identification is incorrect, for instance if the user enters the wrong username and/or password by mistake, flow returns to block 600 at which the user is again prompted for the user identification. If, however, the identification is correct (i.e., the user is authenticated), flow continues to block 606 at which the contacts information module 214, 314 receives the user's request to view the virtual address book, as indicated in block 606. More particularly, the module 214, 314 can receive a request to view a particular folder of the address book. The address book folders can be different, yet potentially overlapping, collections of contacts example folders include “all,” “personal,” and “business” folders. In addition, the user can designate his or her own custom folder categories, if desired.

Once the request is received, the contacts information module 214, 314 presents the user with the requested folder, as indicated in block 608. At this point, the user can browse through the contacts identified within the folder. For instance, where the user had selected the “business” folder, the user can view all business contacts that he or she maintains with the virtual address book. By way of example, each contact is presented as the person's name. Although the contact information for each listed person can be stored locally within the computing device 102, for instance in the local database 218, the listed contacts can comprise mere links to the information that is stored remotely, e.g., in the database 316 of the network server 112. In such an arrangement, the links can comprise, for example, an Internet protocol (IP address) or a transmission control protocol (TCP) port that is used to access the information and local storage space can be spared. In an alternative arrangement, the information can be stored in both the local database 218 and the remote database 316 and the local database updated through periodic reference to the remote database (e.g., weekly) via the communication module 216 and the network interface devices 208. In this manner, the information can be more quickly accessed in that retrieval of the pertinent information form the network 104 is not needed. This updating can occur automatically under the direction of the contracts information module 214, 314 or manually at the discretion of the user, as long as access privileges have not been revoked. In either case, however, the user will normally able to access current contact information for the person.

Next, the contacts information module 214, 314 receives a request to view contact information for a particular person, as indicated in block 610, and then retrieves the requested contact information, as indicated in block 612. Where the contact information is only stored remotely, this latter step comprises accessing the remote database 316 via the network 104 and having the relevant information delivered to the user at the computing device 102. When the contact information is stored locally, this step involves merely calling-up the information from the local database 218. At this point, the contact information is displayed to the user, as indicated in block 614, with the display 206. The user can then use this information to make a call, address a letter, etc. Next, it can be determined whether other information is to be accessed, as indicated in decision element 616. If not, flow is terminated. If so, flow returns to block 610 at which a new request is received. Operating in the manner described above, the contacts information module 214, 314 can be used to provide the user with the most up-to-date contact information available. Therefore, even where the user has not communicated with a particular person for several years, the user will be able to access current contact information for the person, assuming the user's access privileges have not been revoked.

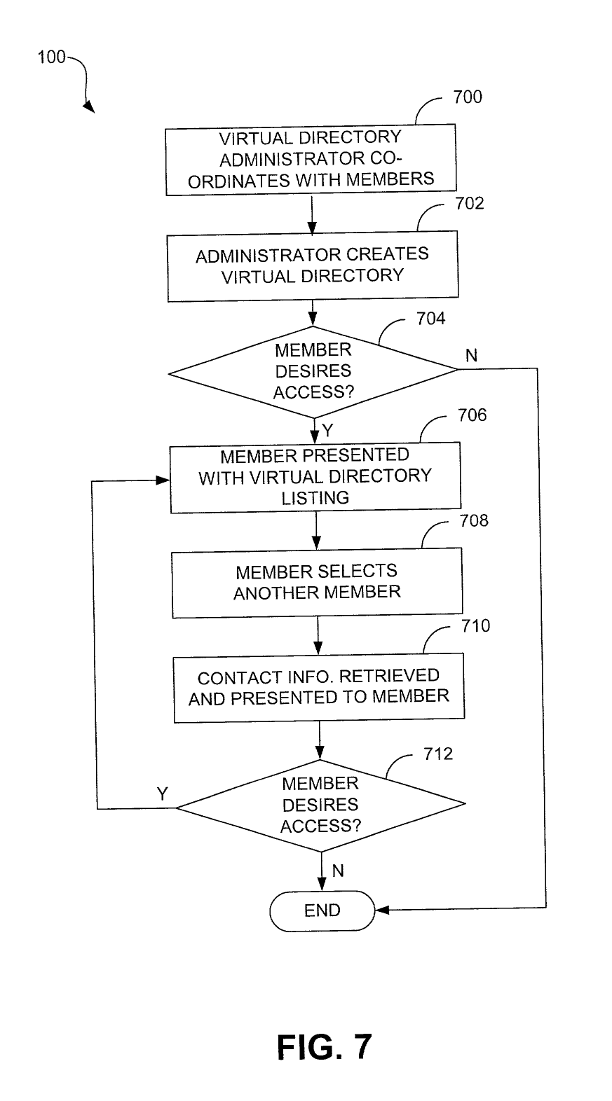

FIG. 7 illustrates an example method for sharing information with the aforementioned system 100. In particular, FIG. 7 describes an example in which a group of persons' contacts information is maintained in a virtual directory accessible by group members across the network 104. The group can comprise a collection of persons that have or had something in common. For example, the group can comprise former students of a particular high school graduating class, members of a particular club, employees of a particular work team, etc. As indicated in block 700, a group administrator first coordinates with each member of the group to determine their willingness to share their personal contact information with other members of the group. For instance, in the high school class scenario, the administrator could be the class president for that graduating class. Preferably, this coordination occurs before the group disbands (where applicable) such that each member's willingness to be included within the virtual directory can more easily be confirmed. For instance, returning to the high school class scenario, the administrator could confirm this willingness prior to or soon after graduation.

Once having determined which members would like to participate, the administrator can create the virtual directory, as indicated in block 702. Optionally, the administrator can provide all the identities of the participating members and their associated contact information to another entity, for instance the entity that maintains the one or more network servers 112. As before, these identities can simply comprise an identifier such as the member's email address or another identifier that is globally unique. The administrator, or other entity, can then configure the virtual directory such that only members of the group and, potentially only participating members, can access the directory.

Once the virtual directory is established, a member (i.e., the user) can determine whether he or she would like to access contact information of another member (i.e., a person), as indicated in decision element 704. If so, flow continues to block 706 in which the member is presented with the virtual directory listing, for instance with the display 206 of the computing device 102. Typically, the member can access the virtual directory in the same manner as described above in terms of accessing folders of the virtual address book. Accordingly, the member normally first logs in with an application of the contacts information module 214, 314 such that the member's authorization to access the virtual directory can be confirmed. Once the directory is presented to the member, the member can select another member whose contact information is desired, as indicated in block 708. As described above, that member's contact information is then retrieved and provided to the requesting member, as indicated in block 710. At this point, the member can determine whether he or she would like to access another member's contact information, at which point flow returns to block 706, or not, at which point flow is terminated.

In view of the above example method, it can be appreciated that, assuming each participating member maintains the accuracy of his or her own contact information, each authorized member of the group will be able to maintain contact with other members even after many years have passed and many or all of the members have moved, changed telephone numbers, and so forth. As with the methods described above in relation to FIGS. 4 and 5, each member has the option to either make his or her contact information available to other members of the group, revoke access to this information (in whole or in part) relative to the group, or modify what information will be accessible to other members of the group (either globally or on a person-by-person basis) at any time. In addition, although not described above, it will be understood that the directories could be public, i.e., accessible by the public in general instead of private. In such a scenario, the method is the same except that special authorization would not be needed to access information and revocation of information would be effected globally as opposed to on a person-by-person basis.

While particular embodiments of the invention have been disclosed in detail in the foregoing description and drawings for purposes of example, it will be understood by those skilled in the art that variations and modifications thereof can be made without departing from the scope of the invention as set forth in the following claims.

What is claimed is:

1. A method for sharing contact information, comprising:
storing a user's contact information in a database accessible over a network;
receiving identification from a user of a person to authorize for access the user's contact information;
enabling the person to access the user's contact information; and
transmitting the user's contact information to a computing device of the authorized person from the database via the network in response to a request for this information.

2. The method of claim 1, wherein the step of storing the user's contact information comprises storing the user's contact information on a network server accessible through the network that is used as a central repository of contacts information.

3. The method of claim 2, wherein the network comprises the Internet.

4. The method of claim 1, wherein the step of receiving identification comprises receiving one of the person's email address.

5. The method of claim 1, wherein the step of enabling the person to access the user's contact information comprises adding the person's identity to an approved list associated with the user's contact information.

6. The method of claim 1, further comprising the step of receiving an indication from the user as to what pieces of contact information to make accessible to the authorized person.

7. The method of claim 1, further comprising the step of revoking a person's access to the user's contact information in response to the user's request to revoke the access.

8. A method for sharing contact information, comprising:
receiving a user's identification that conveys the user's authorization to access contact information;
receiving a request to view contact information;
retrieving the requested contact information from a remote database via a network; and
presenting the contact information to the user.

9. The method of claim 8, wherein the step of receiving a request to view contact information comprises receiving a request from a remote computing device via the network.

10. The method of claim 8, wherein the step of retrieving the requested contact information comprises retrieving the contact information from a network server accessible through the network that is used as a central repository of contacts information.

11. The method of claim 10, wherein the network is the Internet.

12. The method of claim 8, further comprising the step of storing the retrieved contact information in a local database.

13. The method of claim 8, wherein the step of displaying the contact information comprises displaying the contact information to the user with a computing device.

14. A method for sharing contact information, comprising:
storing a user's contact information in a web server accessible via the Internet;
receiving from the user an identification of one or more persons that the user authorizes to access the user's contact information;
receiving identification of what pieces of contact information to share with each authorized person;
receiving a request from a person to view the user's contact information;
verifying authorization of the person to view the user's contact information and the level of access for which the person is approved; and
transmitting appropriate contact information to the person.

15. A system for sharing contact information, comprising:
means for storing a user's contact information in a location accessible over a network;
means for receiving an identification of one or more persons that a user authorizes to access the user's contact information;
means for enabling the persons to access to the user's contact information; and
means for transmitting the user's contact information to a computing devices of the authorized persons from the database in response to requests for this information.

16. The system of claim 15, further comprising the means for receiving an indication from the user as to what pieces of contact information to make accessible to the persons.

17. The system of claim 15, further comprising means for revoking a person's access to the user's contact information.

18. A system for sharing contact information, comprising:
means for verifying a user's authorization to access contact information;
means for receiving a request to view contact information;
means for retrieving the requested contact information from a remote database accessible via a network; and
means for presenting the contact information to the user.

19. The system of claim 18, wherein the means for receiving a request comprises a link to the contact information on the network.

20. The system of claim 18, wherein the means for retrieving the requested contact information comprises network interface devices adapted to retrieve the contact information from a web server connected to the Internet.
